(19) United States
(12) Patent Application Publication
(10) Pub. No.: US 2026/0099339 A1
(43) Pub. Date: Apr. 9, 2026

(54) AUTOMATED SYSTEM RECONFIGURATION

(71) Applicant: Truist Bank, Charlotte, NC (US)

(72) Inventors: Matthew Laine Donlan, Charlotte, NC (US); Joby Kuriakose, Cumming, GA (US)

(73) Assignee: Truist Bank, Charlotte, NC (US)

(21) Appl. No.: 18/909,213

(22) Filed: Oct. 8, 2024

(51) Int. Cl. G06F 9/445

(52) U.S. Cl. CPC G06F 9/44505

(57) ABSTRACT

An application may receive an indication of a status event. A first model may determine, based on a system component repository, a first system component associated with the status event. The first model may determine, based on the first system component and the status event, a modification to the first system component. A second model may generate one or more instructions to implement the modification to the first system component. The application may initiate execution of the one or more instructions to implement the modification to the first system component.

### BACKGROUND

Enterprise systems must often apply and enforce various rules. Conventionally, this is a manually driven process that is specific to a particular type of rule and/or system component. These rules may change, while new rules may be added, and other rules may be removed. Under conventional solutions, responses to changes, new rules, and/or rule removal are manual processes. Furthermore, conventional solutions are often incomplete, as some rule changes may go undetected. Similarly, conventional solutions may not configure all system components which require reconfiguration.

### BRIEF SUMMARY

Embodiments of the present disclosure address the above needs and/or achieve other advantages by providing apparatuses and methods that automate system reconfiguration.

In various embodiments, a method can be used to respond to status events by an application running on one or more processors. This involves receiving an indication of the event and determining the associated system component using a first model based on a system component repository. A second model then determines any required modifications to this component in response to the status event, generating instructions for these changes, which are initiated by the application executing on the processors.

In various embodiments, a method involves an application receiving an indication of a status event. A first model based on a system component repository identifies the associated system component for the status event. The second model uses this information to determine necessary modifications to comply with the status event and generates corresponding instructions. The application then initiates execution of these instructions, resulting in modification implementation for the identified system component.

Similarly, an apparatus comprising a processor and memory storing executable instructions facilitates handling a status event. It receives indications from an application, utilizes models based on a system component repository to identify the related system component, determines modifications required by the status event, generates instructions for implementing these changes, and executes them through the application's initiation.

Furthermore, in an embodiment a non-transitory computer-readable storage medium contains executable instructions that enable processing an indication of a status event. The first model identifies the associated system component using a system component repository while the second model determines necessary modifications and generates corresponding instructions for implementation.

The features, functions, and advantages that have been discussed may be achieved independently in various embodiments of the present disclosure or may be combined in yet other embodiments, further details of which can be seen with reference to the following description and drawings.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

Having thus described embodiments in general terms, reference will now be made to the accompanying drawings, wherein:

FIG. 1 illustrates an aspect of the subject matter in accordance with one embodiment.

FIG. 2A illustrates an aspect of the subject matter in accordance with one embodiment.

FIG. 2B illustrates an aspect of the subject matter in accordance with one embodiment.

FIG. 3 illustrates a logic flow 300 in accordance with one embodiment.

FIG. 4 illustrates a logic flow 400 in accordance with one embodiment.

FIG. 5A is a diagram of a feedforward network, according to at least one embodiment, utilized in machine learning.

FIG. 5B is a diagram of a convolution neural network, according to at least one embodiment, utilized in machine learning.

FIG. 5C is a diagram of a portion of the convolution neural network of FIG. 5B, according to at least one embodiment, illustrating assigned weights at connections or neurons.

FIG. 6 is a diagram representing an exemplary weighted sum computation in a node in an artificial neural network.

FIG. 7 is a diagram of a Recurrent Neural Network (RNN), according to at least one embodiment, utilized in machine learning.

FIG. 8 is a schematic logic diagram of an artificial intelligence program including a front-end and a back-end algorithm.

FIG. 9 is a flow chart representing a method, according to at least one embodiment, of model development and deployment by machine learning.

FIG. 10 illustrates a computing system 1000 in accordance with one embodiment.

### DETAILED DESCRIPTION

Embodiments disclosed herein provide techniques to automatically reconfigure systems comprising various resources. The reconfiguration may result in compliance with rules, regulations, laws, or any type of parameter (which may be collectively referred to as “rules” herein). A status event associated with a rule may include the receipt of a new rule, modification of an existing rule, removal of an existing rule, and/or a request to analyze the system and an input rule. In response to a status event, embodiments disclosed herein may access the rule and determine a plurality of system components associated with performing a function that requires compliance with the rule. In some embodiments, the plurality of system components are identified based on a system component repository (also referred to as a system catalog) that includes metadata describing the components in a system. For example, a large language model (LLM) may process or otherwise analyze the rule and system component repository to identify the plurality of components. Doing so identifies all system components that may need to be updated to comply with the rule.

In some embodiments, one or more corrective actions may be generated to reconfigure the identified system components to comply with the rule. For example, an LLM may generate code (e.g., computer executable instructions) that cause software to comply with the rule. As another example, the LLM may generate modified parameters for operating systems, hardware, networks, network infrastructure, system infrastructure, etc. These corrective actions may be implemented in the system such that the system as a whole complies with all applicable rules.

For example, a payment application may be subject to various rules, laws, and/or regulations. However, multiple system components may be involved in processing operations associated with the payment application. For example, a user-facing component of the application may receive input to initiate a transaction, one or more network segments may transport associated data, various servers may process the data, and various software elements may be used to process the transaction (e.g., components of the application, databases, etc.). To determine compliance, embodiments disclosed herein may analyze the rule, determine the payment application is subject to the rule, and identify the plurality of system components associated with the payment application. Embodiments disclosed herein may then identify specific elements of the system components that require modification to comply with the rule. For example, the user-facing portion of the application may need to be updated to provide a “cancel transaction” feature, while various server-side application segments need to be modified to support the “cancel transaction” feature. Advantageously, embodiments disclosed herein may analyze the code of the payment application, generate code statements to cause the application to comply with the rule, and insert the code statements at appropriate locations in the source code of the application. Thereafter, once recompiled and deployed, the application code (and the system as a whole), may comply with the rule. Embodiments are not limited in these contexts.

Advantageously, embodiments disclosed herein identify rules, laws, regulations, etc., that require compliance by a system. Furthermore, embodiments disclosed herein identify the system components that must comply with these rules. Doing so pinpoints, for a given rule, system components that need to be reconfigured to comply with the rule. Doing so improves computing systems by providing limited subset of system components that need to be reconfigured, rather than processing each system component to determine whether compliance with the rule is necessary. Doing so improves the security and compliance of the system, and reduces the amount of time and resources required to pinpoint the system components that are affected by the rule. Moreover, by generating code, instructions, system configuration parameters, etc., embodiments disclosed herein may automatically reconfigure the system to comply with the rule. Doing so improves the functioning, security, and compliance of the system with various rules, which are constantly evolving over time. Doing so reduces the amount of time and resources necessary to manually reconfigure each system component. Moreover, embodiments disclosed herein reduce the number of rules that a system does not comply with, reduces the number of system components that do not comply with a rule, and generally causes a system to be in constant compliance with all applicable rules. Embodiments are not limited in these contexts.

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the disclosure and enable one of ordinary skill in the art to make, use, and practice the disclosure.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

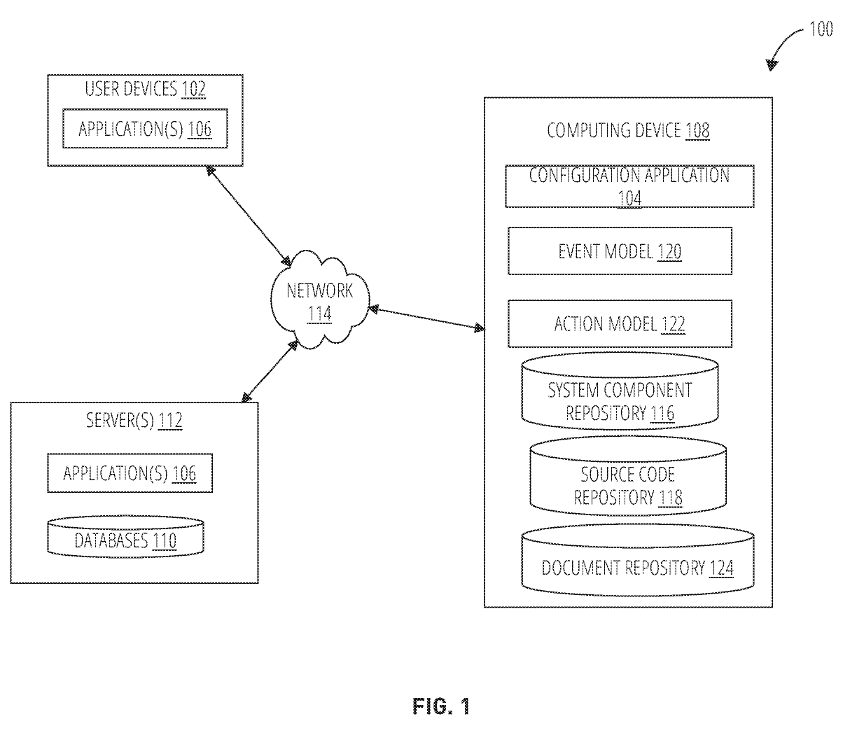

FIG. 1 illustrates an example system 100 that is automatically reconfigured, according to one embodiment. As shown, the system 100 comprises one or more user devices 102, one or more computing devices 108, and one or more servers 112 communicably coupled via one or more networks 114. The user devices 102, computing device 108, and/or servers 112 are representative of any type of physical and/or virtualized computing system. For example, the user devices 102, computing devices 108, and/or servers 112 may be implemented as servers, workstations, laptops, mobile devices, smartphones, tablet computers, mainframes, distributed computing systems, compute clusters, media devices, cameras, gaming devices, system-on-chips (SoCs), televisions, wearable devices, virtual machines (VMs), or any other device with processing capabilities.

As shown, the servers 112 execute, host, or otherwise store one or more applications 106 and one or more databases 110. Similarly, the user devices 102 may execute, host, or otherwise store one or more of the applications 106. The applications 106 of the servers 112 may be the same as or different than the applications 106 of the user devices 102. In some embodiments, the user devices 102 store instances of the databases 110. In some embodiments, the computing device 108 is one of the servers 112, and therefore may host, execute, or otherwise store applications 106 and/or database 110. The user devices 102, servers 112, and/or computing devices 108 may further include other components not depicted for the sake of clarity (e.g., operating systems, processors, memory, application programming interfaces (APIs), services, microservices, etc.).

The applications 106 are representative of any number and type of application. For example, the applications 106 may include web browsers, account management applications, mobile P2P payment system client applications, applications provided by financial institutions, financial applications, payment applications, Automated Clearing House (ACH) applications, FedNow payment applications, real-time payments (RTP) applications, monetary transfer applications, mobile wallet applications, accounting applications, payment processing frameworks, etc. Although depicted as applications, the applications 106 may are representative of any type of executable code, such as services, microservices, application programming interfaces (APIs), etc. Regardless of the type of a given applications 106, in some embodiments, the applications 106 may include features to process at least a portion of a transaction. The transactions may include purchases, payments, equity transactions, cryptocurrency sales, or any type of transaction. Furthermore, a given transaction may be processed at least in part by multiple portions of one or more applications 106.

The databases 110 are representative of any type of database, such as account databases for customer accounts, databases for payment accounts, production databases for applications, financial institution databases, databases for cached data, and databases for files such as those for user accounts, user profiles, account balances, and transaction histories, files downloaded or received from other devices, and other data items and the like. Example accounts include a checking account, a savings account, a money market account, a certificate of deposit, a mortgage or other loan account, a retirement account, a brokerage account, or any other type of account.

As shown, the computing device 108 includes a configuration application 104, an event model 120, an action model 122, a system component repository 116, a source code repository 118, and a document repository 124. The configuration application 104 is generally configured to configure the components of a system such as system 100. Doing so may cause the components of system 100 to comply with rules and other requirements specified in documents in the document repository 124. The documents in the document repository 124 may include rules, laws, regulations, parameters, requirements, and any other type of text requiring compliance. The documents in the document repository 124 may be periodically updated, e.g., by the configuration application 104 identifying new (and/or updated or repealed) laws, rules, regulations, etc., and storing the same in the document repository 124.

The system component repository 116 generally stores data describing the various components of the system 100 (and/or other components of the system 100 not pictured). For example, the system component repository 116 may include entries for the applications 106 (and/or components thereof), database 110 (and/or components thereof), servers 112 (and/or components thereof), computing devices 108 (and/or components thereof), user devices 102 (and/or components thereof), etc. A given entry may include metadata describing the associated component, such as configuration parameters, physical locations, network locations, data storage locations, dependencies (e.g., dependencies on other software and/or hardware components), associated users (e.g., project managers, developers, etc.), and textual descriptions of the associated component. The configuration parameters for the associated component may include any configurable parameter (e.g., CPU cycles, disk access, network bandwidth, I/O bandwidth, memory access, queue sizes, priorities, etc.) The textual descriptions may be created by a user and/or a component of the system 100 (e.g., the configuration application 104, the event model 120, action model 122, etc.).

A given textual description in the system component repository 116 may include text describing the system component, features of the system component, functionality of the system component, or any other attribute of the system component. For example, the following textual description is an example of at least a portion of a textual description that may be included in the system component repository 116 for a database 110 that stores payment transaction information: “the payment transaction history database 110 designed to securely store and manage detailed records of all financial transactions processed through a payment system. Each transaction entry includes essential fields such as transaction ID, user ID, amount, date and time of the transaction, payment method (credit card, debit, digital wallet, etc.), merchant ID, and transaction status (completed, pending, failed). The database schema is optimized for efficient querying and reporting, enabling businesses to track revenue, analyze user spending patterns, and resolve disputes swiftly....The source code for the database management system (DBMS) is built in a combination of Python and SQL stored at “path://location”, ensuring seamless integration with existing backend services. Data is stored in a cloud-based relational database, such as PostgreSQL, to provide scalability and redundancy. The architecture includes automated backup solutions and geographic distribution to enhance data durability. Security measures include encryption for sensitive data, access controls to limit visibility to authorized personnel, and comprehensive audit logs that track changes and access attempts, ensuring compliance with requirements imposed by regulation ABC. Security features to comply with regulation ABC are implemented in lines x-z of the source code of the DBMS. With the capability to integrate with other financial systems and reporting tools, this database serves as a critical component in enhancing financial oversight and improving customer service.” Embodiments are not limited in these contexts.

The source code repository 118 includes the source code of the software elements of the system 100, e.g., the applications 106, databases 110 or any other software used in the system 100 (e.g., APIs, microservices, etc.).

The event model 120 and action model 122 are artificial intelligence (AI) models. The event model 120 and action model 122 may be implemented as any type of AI model, such as machine learning (ML) models, neural networks, large language models (LLMs), etc. The use of LLMs as reference examples of the event model 120 and action model 122 should therefore not be considered limiting of the disclosure. Although depicted as being external to the configuration application 104, in some embodiments, the action model 122 and the event model 120 are components of the configuration application 104.

In some embodiments, the event model 120 is trained on the system component repository 116. In some embodiments, the event model 120 is trained on the system component repository 116 and the document repository 124. Generally, the training of the event model 120 based at least in part on the system component repository 116 (and optionally the document repository 124) allows the event model 120 to identify how the components of the system 100 adhere to one or more rules in a given document in the document repository 124. Furthermore, the training of the event model 120 allows the event model 120 to identify which system components are associated with a given document in the document repository 124 and/or one or more rules included therein. Further still, the training of the event model 120 allows the event model 120 to determine various workflows and/or processing flows that include subsets of the resources of the system 100.

For example, the event model 120 may be trained to determine which software elements and which hardware elements of the system 100 are used to process mobile wallet transactions. Furthermore, the event model 120 may be trained to determine how the determined elements of the system 100 comply with various rules in the document repository 124 associated with mobile wallet transactions. Further still, the event model 120 may be trained to determine the processing flow (or workflow) for processing mobile wallet transactions. In embodiments where the event model 120 is trained on the document repository 124, the event model 120 may further be trained to extract concepts, rules, parameters, or other requirements from a given document.

Training the event model 120 may include preprocessing the training data in the system component repository 116 and/or the document repository 124. For example, the training data may be structured and cleaned to ensure consistency. The training data may be annotated to highlight key components, entities, relationships, and attributes. The annotation may comprise marking fields to allow the event model 120 to understand context and importance. The training data may also be formatted to emphasize structure, such as using JSON or XML representations.

The training dataset is then used to train the event model 120. During this process, the event model 120 learns patterns and associations within the text, reflecting how a given system component complies with a given rule. This may include feeding the event model 120 training examples that include descriptions from the system component repository 116 and/or additional materials, such as use cases, documentation and/or source code from the source code repository 118, configuration in the system component repository 116, system architectures, etc.

The action model 122 may be trained to generate corrective actions to modify the components of the system 100 to comply with a rule. For example, the corrective actions may include generating source code that complies with a rule for an application 106, generating updated configuration parameters to comply with a rule for the network 114 (e.g., to route data such that it does not leave a particular geographic region, etc.), generating configuration parameters for the servers 112 (e.g., queue hold times, transaction processing times, etc.), generating configuration parameters for the user devices 102, etc.

In some embodiments, the action model 122 is trained on the source code repository 118. Doing so allows the action model 122 to generate source code that is compatible with the other components in the system 100 while remaining compliant with applicable rules. In some embodiments, the source code repository 118 includes the system configuration data from the system component repository 116, e.g., configuration parameters, physical locations, network locations, data storage locations, dependencies (e.g., dependencies on other software and/or hardware components), etc., described above. In some embodiments, the action model 122 is trained on the source code repository 118 and the configuration data from the system component repository 116 (and optionally other data in the system component repository 116).

The training of the action model 122 may include preprocessing the training data, e.g., the data in the source code repository 118. For example, the training data may be structured and cleaned to ensure consistency. The training data may be annotated to highlight key components, entities, relationships, and attributes. The annotation may comprise marking fields to allow the action model 122 to understand context and importance. The training data may also be formatted to emphasize structure, such as using JSON or XML representations.

The training dataset is then used to train the action model 122. During this process, the action model 122 learns patterns and associations within the training data, reflecting how code is written, including how code is written to comply with rules. This may include feeding the action model 122 training examples that include source code from the source code repository 118 and/or additional materials, such as use cases, documentation, system configuration, system architectures, etc.

Once trained, the event model 120 and the action model 122 may be used to reconfigure the system 100 to ensure compliance by the system 100 with rules in the document repository 124. For example, the configuration application 104 may detect a new document stored in the document repository 124, receive a trigger when a document is stored or updated in the document repository 124, receive a trigger when a document is removed from the document repository 124, etc. As another example, a user may specify a document from the document repository 124 as part of a request to the configuration application 104 to ensure compliance. As another example, the configuration application 104 may execute at periodic time intervals to ensure compliance.

More generally, the configuration application 104 may receive or access a document or other text including one or more rules (e.g., a law, a regulation, etc.) as input. The configuration application 104 may then process the document, e.g., to identify concepts, terms, rules, parameters, etc., therein. In some embodiments, the configuration application 104 may use the event model 120 to process the document, where the event model 120 (or another model) has been trained to extract rules or other parameters from a document. Such a model may be trained on the document repository 124. The configuration application 104 may then invoke the event model 120 to determine one or more components of the system 100 that are associated with the document.

For example, the document may be a law related to cryptocurrency transactions. The configuration application 104 may provide the document to the event model 120, which identifies concepts in the cryptocurrency law and one or more components of the system 100 associated with these concepts. For example, the event model 120 may determine that the new law limits cryptocurrency transactions to 10 transactions per day per wallet. Therefore, the event model 120 may identify one or more applications 106 associated with processing cryptocurrency transactions, one or more user devices 102 associated with processing cryptocurrency transactions, and one or more servers 112 associated with processing cryptocurrency transactions. In some embodiments, the configuration application 104 provides a “heatmap” of the identified components of the system 100 (and/or users).

The event model 120 may further determine one or more existing compliance solutions for the cryptocurrency law. For example, the law may be an updated version of the law, which previously limited transactions to 5 per account per day. Therefore, the event model 120 may determine where and how these previous limitations were implemented. For example, the event model 120, having been trained on the system component repository 116, may determine that a cryptocurrency application 106 that executes on user devices 102 includes source code to limit the number of transactions to fiver per day per account.

In other embodiments, e.g., when a new law is passed (and therefore previous compliance solutions for the law do not exist), the event model 120 may determine where relevant features of the identified components of the system 100 are located. For example, the trained event model 120 may determine that transaction submission for the application 106 on the user devices 102 is processed by a specific library for the application 106 in the source code repository 118. As another example, the event model 120 may determine locations of rules in the source code repository 118 for processing transactions by the cryptocurrency application 106 on the servers 112. Embodiments are not limited in these contexts.

Based on the processing, the event model 120 may determine one or more solutions to comply with the regulation. For example, the event model 120 may determine that the application 106 on user devices 102 and the servers 112 need to be updated to limit cryptocurrency transactions to 10 per day per account. The event model 120 may provide indications of the one or more solutions to the action model 122. In some embodiments, the event model 120 provides additional and/or alternate information to the action model 122. For example, the event model 120 may indicate that the cryptocurrency transaction limit has been set to 10 per day per account. As another example, the event model 120 may indicate that the cryptocurrency transaction limit has been updated from 5 per day to 10 per day per account. In addition and/or alternatively, the event model 120 may provide, to the action model 122, indications of the components of the system 100 that are affected by the rules.

The action model 122 may then process the input received input to generate source code, configuration parameters, etc., to ensure compliance. For example, the action model 122 may generate source code that limits the cryptocurrency transactions to 10 per day. The source code may be generated for each component identified by the event model 120 (e.g., the application 106 on the user devices 102, the applications 106 on the servers 112, etc.). The action model 122 and/or the configuration application 104 may then store the generated source code in the source code repository 118. In some embodiments, the configuration application 104 may initiate compilation and deployment of the generated source code such that the system 100 automatically complies with the cryptocurrency law. In some embodiments, user input approving the compilation and deployment of the source code is received as a precondition to compiling and deploying the source code. For example, users associated with a given resource in the system 100 may be notified by the configuration application 104 of any proposed code and/or configuration changes.

In one embodiment, when a user decides to enroll in a mobile banking program, the user downloads or otherwise obtains the mobile banking system client application from a mobile banking system, for example system 100, or from a distinct application server. In other embodiments, the user interacts with a mobile banking system via a web browser application in addition to, or instead of, the mobile P2P payment system client application.

The network 114 may also incorporate various cloud-based deployment models including private cloud (e.g., an organization-based cloud managed by either the organization or third parties and hosted on-premises or off premises), public cloud (e.g., cloud-based infrastructure available to the general public that is owned by an organization that sells cloud services), community cloud (e.g., cloud-based infrastructure shared by several organizations and manages by the organizations or third parties and hosted on-premises or off premises), and/or hybrid cloud (e.g., composed of two or more clouds e.g., private community, and/or public).

The user devices 102 may include automatic teller machines (ATMs) utilized by the system 100 in serving users. In another example, the user devices 102 and/or servers 112 represent payment clearinghouse or payment rail systems for processing payment transactions, and in another example, the servers 112 such as merchant systems or banking systems configured to interact with the user devices 102 during transactions and also configured to interact with the enterprise system 100 (e.g., the servers 112 and/or computing devices 108) in back-end transactions clearing processes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The system 100 can offer any number or type of services and products to one or more users. In some examples, an enterprise system 100 offers products. In some examples, an enterprise system 100 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 100, automated assistance may be provided by the enterprise system 100. For example, automated access to user accounts and replies to inquiries may be provided by enterprise-side automated voice, text, and graphical display communications and interactions. In at least some examples, any number of human agents, can be employed, utilized, authorized or referred by the enterprise system 100. Such human agents can be, as non-limiting examples, point of sale or point of service (POS) representatives, online customer service assistants available to users, advisors, managers, sales team members, and referral agents ready to route user requests and communications to preferred or particular other agents, human or virtual.

Human agents may utilize agent devices (e.g., user devices 102) to serve users in their interactions to communicate and take action. In such embodiments, the user devices 102 can be, as non-limiting examples, computing devices, kiosks, terminals, smart devices such as phones, and devices and tools at customer service counters and windows at POS locations.

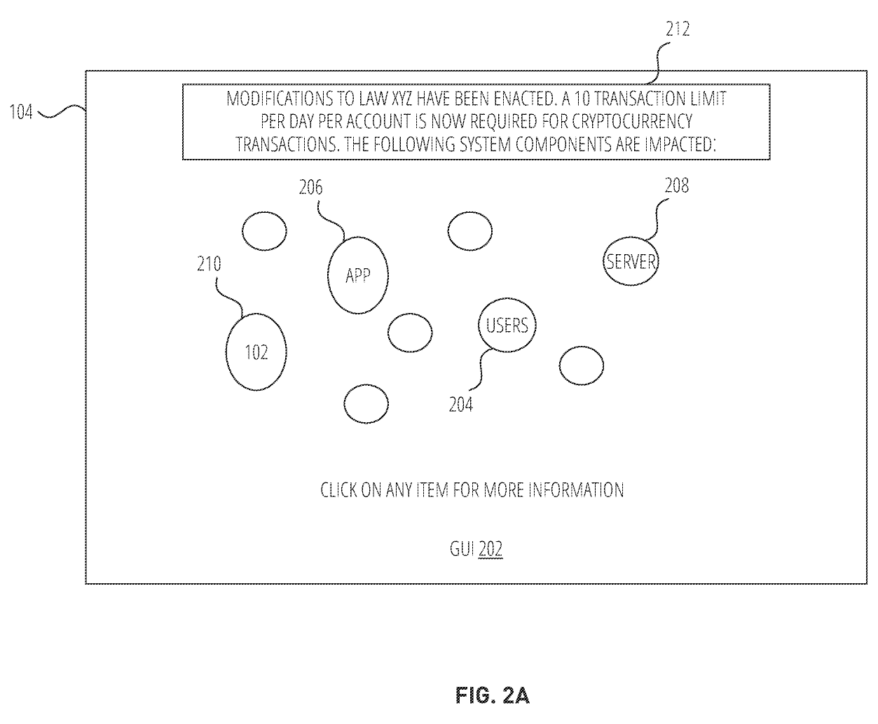

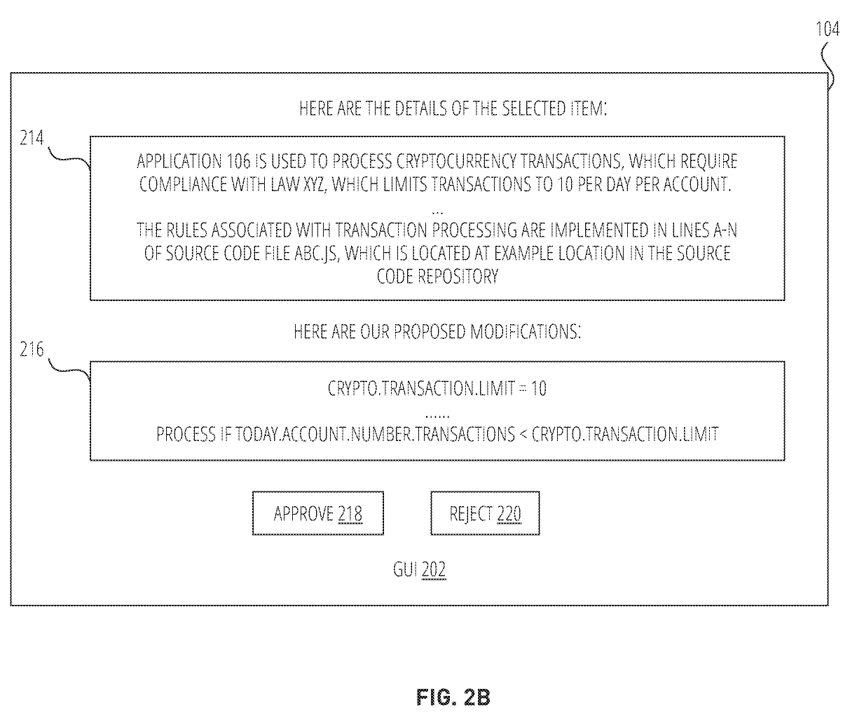

FIG. 2A illustrates a graphical user interface (GUI) 202 generated by the configuration application 104, according to one embodiment. As shown, the GUI 202 includes a text summary 212 describing the change to the cryptocurrency law from the example of FIG. 1. The text summary 212 may be generated by the event model 120 based on the text of the law (e.g., in a document in the document repository 124). As shown, the GUI 202 includes selectable elements 204-210 which correspond to the components of the system 100 that are impacted by the law and for which compliance must be ensured. For example, selectable element 204 corresponds to one or more users (or a group of users), selectable element 206 corresponds to one of the applications 106, selectable element 208 corresponds to one of the servers 112, and selectable element 210 corresponds to the user devices 102. Therefore, in some embodiments, the GUI 202 is a heatmap of impacted components. A user may select one of the selectable elements 204-210, which in turn provides more information to the user.

FIG. 2B illustrates an example where the user selects selectable element 206 of GUI 202, according to one embodiment. As shown, the GUI 202 includes a portion of an entry 214 associated with application 106 from system component repository 116. The portion of the entry 214 associated with application 106 in system component repository 116 includes a textual description of the application 106. Furthermore, the entry indicates that application 106 is associated with processing cryptocurrency transactions and specific locations of the source code of application 106 that are associated with transaction processing rules.

As shown, the GUI 202 further includes a portion of source code 216 generated by the action model 122 for the application 106. As shown, the source code 216 reflects the 10 transaction limit and conditions processing a transaction if the number of transactions processed by the account during that day are below the 10 transaction threshold. Embodiments are not limited in these contexts.

In some embodiments, the configuration application 104 may implement the source code 216 in the system 100. For example, the configuration application 104 may store the source code 216 in the source code repository 118, compile the source code 216, deploy the source code 216 in the system 100, etc. As shown, however, the configuration application 104 may present options to a user to approve the submission of the source code 216. For example, the user may approve the implementation of the source code 216 via the approve button 218 or reject implementation of the source code 216 via the reject button 220. In some embodiments, the user may edit the source code 216 prior to submission. Embodiments are not limited in these contexts.

More generally, as stated, the event model 120 may determine a plurality of components of the system 100 that may require reconfiguration. The action model 122 may generate source code 216, other configurable parameters, etc., that can be implemented to modify the functioning of a given component in the system 100. For example, the action model 122 may generate operating system parameters for one of the servers 112. The configuration application 104 may cause the generated parameters to be applied to the operating system of the server 112. Embodiments are not limited in these contexts.

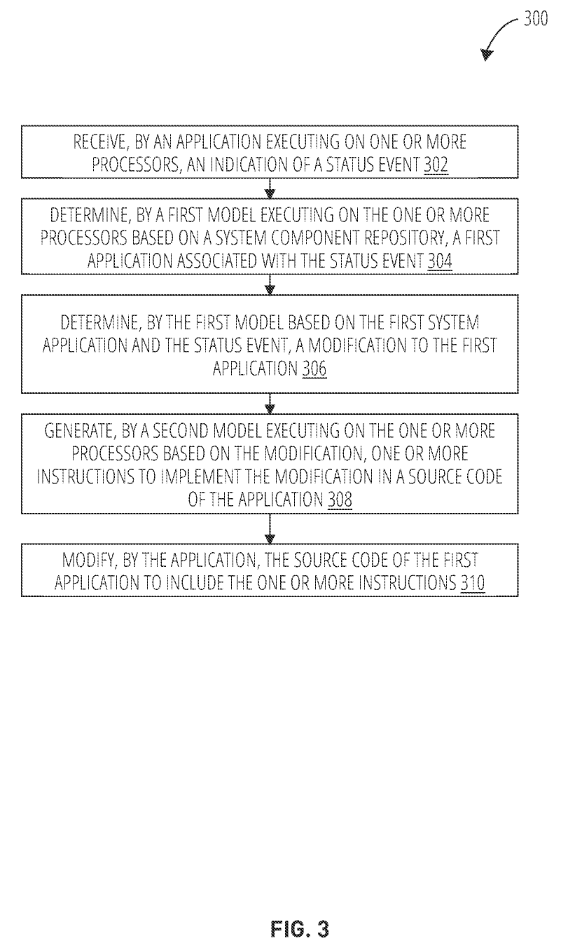

FIG. 3 illustrates an example logic flow 300 for automatically reconfiguring systems for compliance. Although the example logic flow 300 depicts a particular sequence of operations, the sequence may be altered without departing from the scope of the present disclosure. For example, some of the operations depicted may be performed in parallel or in a different sequence that does not materially affect the function of the logic flow 300. In other examples, different components of an example device or system that implements the logic flow 300 may perform functions at substantially the same time or in a specific sequence.

According to some examples, the logic flow 300 includes receiving, by an application executing on one or more processors, an indication of a status event at block 302. For example, the configuration application 104 illustrated in FIG. 1 may receive an indication of a status event. The status event may be the addition of a new document (e.g., a law, rule, regulation, etc.) to the document repository 124, modification of an existing document in the document repository 124, removal of a document from the document repository 124, etc. For example, the status event may be a new law that requires a 3 hour escrow holding period for transactions over $50,000.

According to some examples, the logic flow 300 includes determining, by a first model executing on the one or more processors based on a system component repository, a first application associated with the status event at block 304. For example, the event model 120 illustrated in FIG. 1 may determine, based on the system component repository 116, a first application associated with the status event. For example, the event model 120 may determine that application 106 is associated with at least partially processing transactions over $50,000 based on the system component repository 116.

According to some examples, the logic flow 300 includes determining, by the first model based on the first system application and the status event, a modification to the first application required to comply with the status event at block 306. For example, the event model 120 illustrated in FIG. 1 may determine, based on the first system application and the status event, a modification to the first application. For example, the event model 120 may determine that the source code of the application 106 needs to be updated to implement a 3 hour escrow holding period for transactions over $50,000.

According to some examples, the logic flow 300 includes generating, by a second model based on the modification, one or more instructions to implement the modification in a source code of the application at block 308. For example, the action model 122 illustrated in FIG. 1 may generate one or more instructions to implement the modification in a source code of the application. For example, the action model 122 may generate source code to implement a 3 hour escrow holding period for transactions over $50,000 in the application 106.

According to some examples, the logic flow 300 includes modifying, by the application, the source code of the first application to include the one or more instructions at block 310. For example, the configuration application 104 illustrated in FIG. 1 may store the source code generated at block 308 in the source code repository 118. Doing so ensures the application 106 complies with the 3 hour holding period. Embodiments are not limited in these contexts.

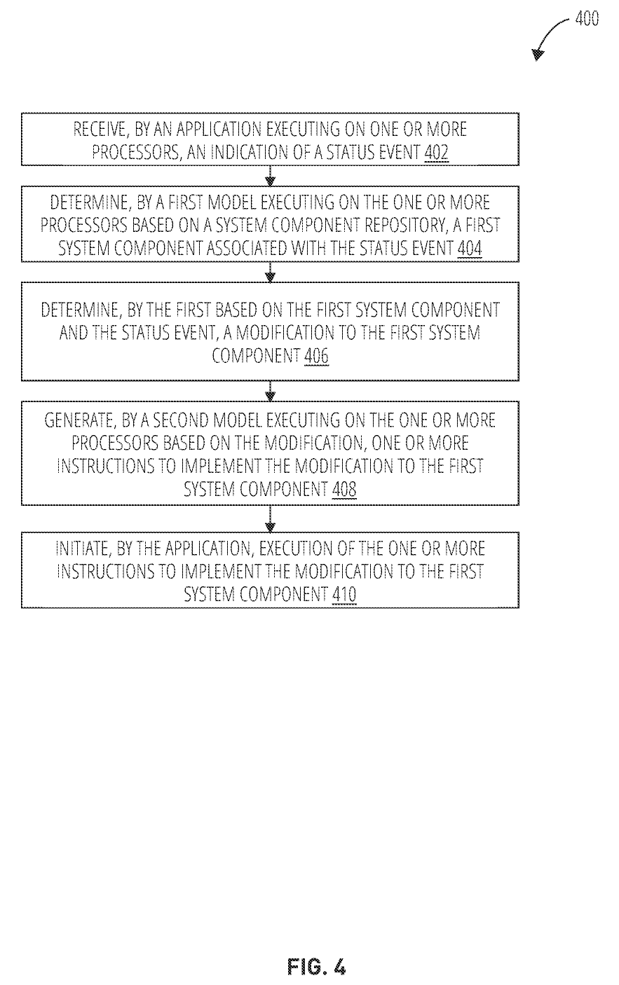

FIG. 4 illustrates an example logic flow 400 for automatically reconfiguring systems for compliance. Although the example logic flow 400 depicts a particular sequence of operations, the sequence may be altered without departing from the scope of the present disclosure. For example, some of the operations depicted may be performed in parallel or in a different sequence that does not materially affect the function of the logic flow 400. In other examples, different components of an example device or system that implements the logic flow 400 may perform functions at substantially the same time or in a specific sequence.

According to some examples, the logic flow 400 includes receiving, by an application executing on one or more processors, an indication of a status event at block 402. For example, the configuration application 104 illustrated in FIG. 1 may receive an indication of a status event. The status event may be the addition of a new document (e.g., a law, rule, regulation, etc.) to the document repository 124, modification of an existing document in the document repository 124, removal of a document from the document repository 124, etc. For example, the status event may be a revision to the law that requires a 3 day escrow holding period for transactions over $500000.

According to some examples, the logic flow 400 includes determining, by a first model executing on the one or more processors based on a system component repository, a first system component associated with the status event at block 404. For example, the event model 120 illustrated in FIG. 1 may determine, based on a system component repository 116, a first system component associated with the status event. For example, the event model 120 may determine that application 106 is associated with at least partially processing transactions over $500000 based on the system component repository 116.

According to some examples, the logic flow 400 includes determining, by a second model based on the first system component and the status event, a modification to the first system component at block 406. For example, the event model 120 illustrated in FIG. 1 may determine, based on the first system component and the status event, a modification to the first system component required to comply with the status event. For example, the event model 120 may determine that the source code of the application 106 needs to be updated to implement a 3 day escrow holding period for transactions over $500000. For example, the action model 122 may generate source code to implement a 3 day escrow holding period for transactions over $500000 in the application 106.

According to some examples, the logic flow 400 includes generating, by the second model, one or more instructions to implement the modification to the first system component at block 408. For example, the action model 122 illustrated in FIG. 1 may generate, based on the identified modification, one or more instructions to implement the modification to the first system component.

According to some examples, the logic flow 400 includes initiating, by the application, execution of the one or more instructions to implement the modification to the first system component at block 410. For example, the configuration application 104 illustrated in FIG. 1 may initiate, by the application, execution of the one or more instructions to implement the modification to the first system component. For example, the configuration application 104 illustrated in FIG. 1 may store the source code generated at block 408 in the source code repository 118, compile the code, and execute the compiled code (e.g., the application 106). Doing so ensures the application 106 complies with the 3 day holding period. Embodiments are not limited in these contexts.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subject matter of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network in response to the training data with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between -1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

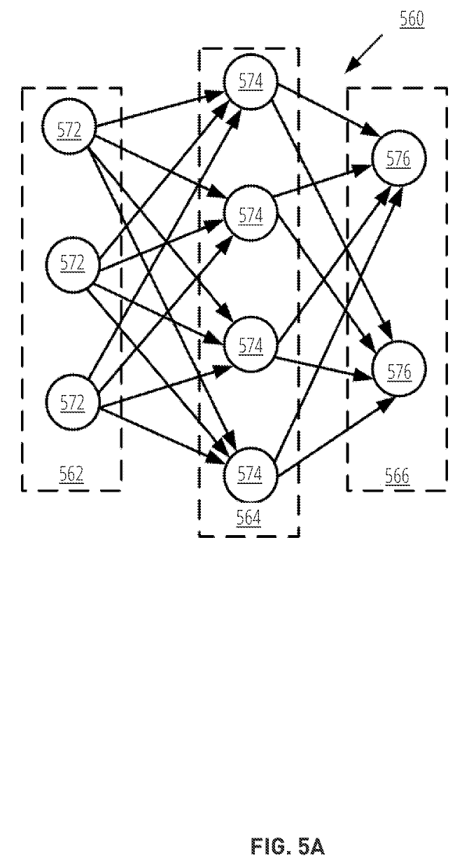

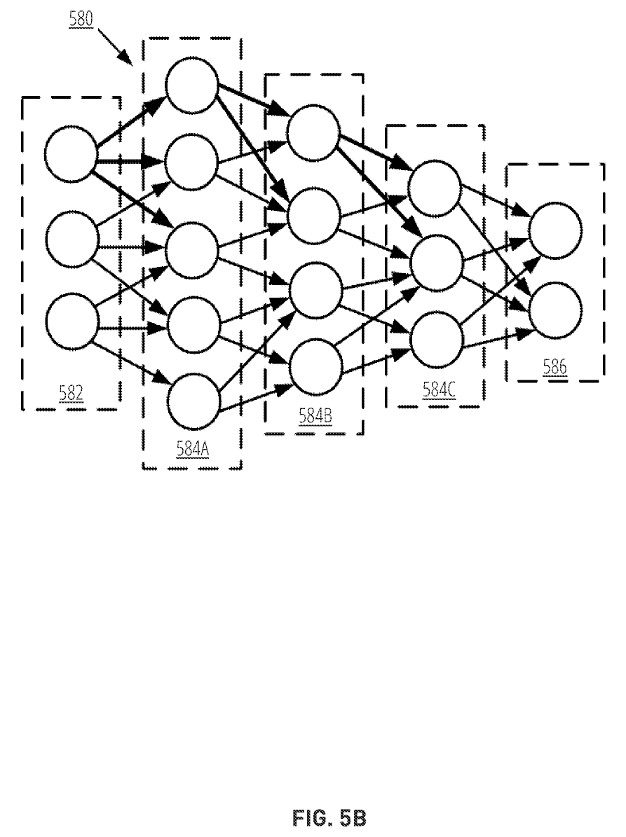

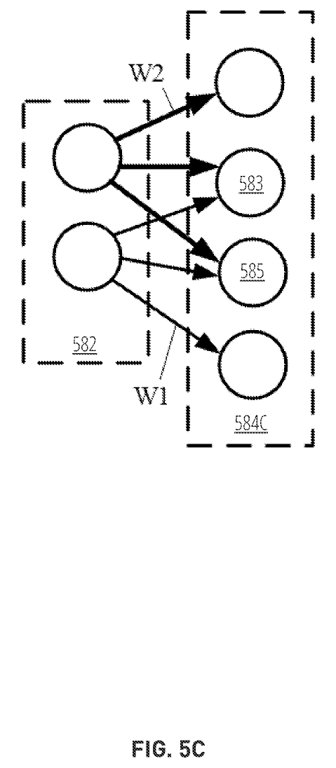

An artificial neural network (ANN), also known as a feedforward network, may be utilized, e.g., an acyclic graph with nodes arranged in layers. A feedforward network (see, e.g., feedforward network 560 referenced in FIG. 5A) may include a topography with a hidden layer 564 between an input layer 562 and an output layer 566. In some embodiments, the event model 120 and/or action model 122 may include one or more instances of the feedforward network 560. The input layer 562, having nodes commonly referenced in FIG. 5A as input nodes 572 for convenience, communicates input data, variables, matrices, or the like to the hidden layer 564, having nodes 574. The hidden layer 564 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 572 of the input layer, which then communicates the data to the hidden layer 564. The hidden layer 564 may be configured to determine the state of the nodes in the respective layers and assign weight coefficients or parameters of the nodes based on the edges separating each of the layers, e.g., an activation function implemented between the input data communicated from the input layer 562 and the output data communicated to the nodes 576 of the output layer 566. It should be appreciated that the form of the output from the neural network may generally depend on the type of model represented by the algorithm. Although the feedforward network 560 of FIG. 5A expressly includes a single hidden layer 564, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 580 in FIG. 5B. As in the basic feedforward network 560 of FIG. 5A, the illustrated example of FIG. 5B has an input layer 582 and an output layer 586. However where a single hidden layer 564 is represented in FIG. 5A, multiple consecutive hidden layers 584A, 584B, and 584C are represented in FIG. 5B. The edge neurons represented by white-filled arrows highlight that hidden layer nodes can be connected locally, such that not all nodes of succeeding layers are connected by neurons. In some embodiments, the event model 120 and/or action model 122 may include one or more of the convolutional neural networks 580.

FIG. 5C, representing a portion of the convolutional neural network 580 of FIG. 5B, specifically portions of the input layer 582 and the first hidden layer 584A, illustrates that connections can be weighted. In the illustrated example, labels W1 and W2 refer to respective assigned weights for the referenced connections. Two hidden nodes 583 and 585 share the same set of weights W1 and W2 when connecting to two local patches.

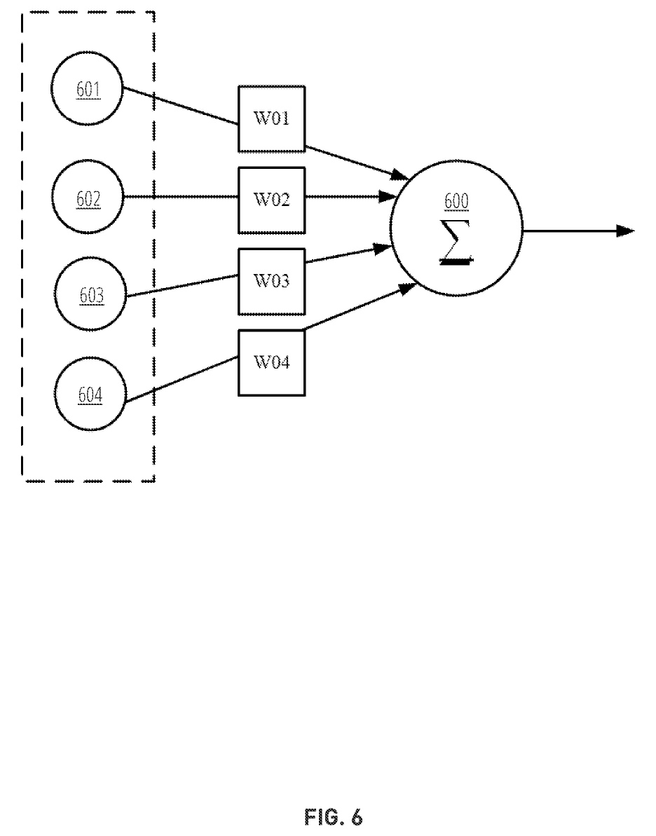

Weight defines the impact a node in any given layer has on computations by a connected node in the next layer. FIG. 6 represents a particular node 600 in a hidden layer. The node 600 is connected to several nodes in the previous layer representing inputs to the node 600. The input nodes 601, 602, 603 and 604 are each assigned a respective weight W01, W02, W03, and W04 in the computation at the node 600, which in this example is a weighted sum. A plurality of nodes 600 and associated weights may be included in the event model 120 and/or the action model 122.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

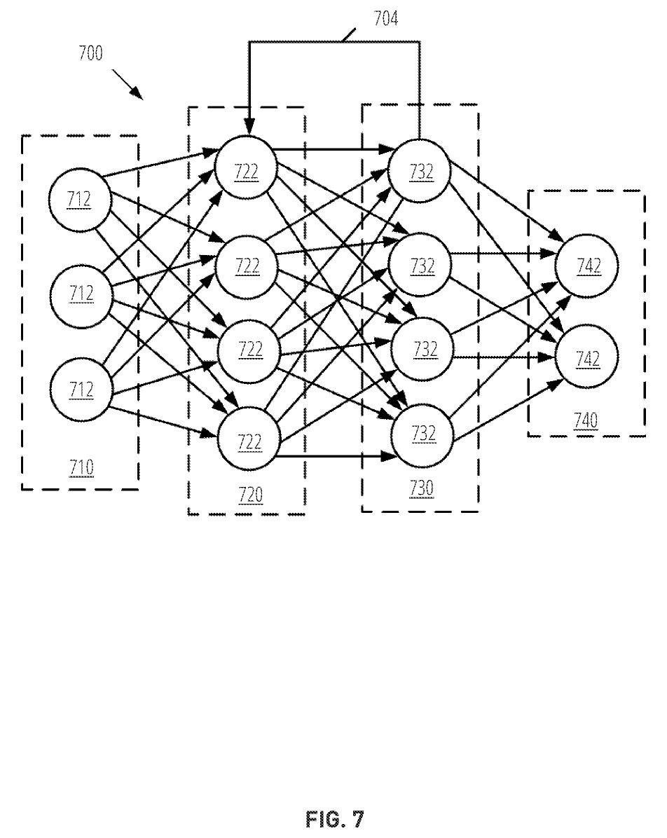

An example for a Recurrent Neural Network (RNN) is referenced as 700 in FIG. 7. In some embodiments, the event model 120 and/or action model 122 may include one or more of the RNNs 700. As in the basic feedforward network 560 of FIG. 5A, the illustrated example of FIG. 7 has an input layer 710 (with nodes 712) and an output layer 740 (with nodes 742). However, where a single hidden layer 564 is represented in FIG. 5A, multiple consecutive hidden layers 720 and 730 are represented in FIG. 7 (with nodes 722 and nodes 732, respectively). As shown, the RNN 700 includes a feedback connector 704 configured to communicate parameter data from at least one node 732 from the second hidden layer 730 to at least one node 722 of the first hidden layer 720. It should be appreciated that two or more and up to all of the nodes of a subsequent layer may provide or communicate a parameter or other data to a previous layer of the RNN 700. Moreover and in some embodiments, the RNN 700 may include multiple feedback connectors 704 (e.g., connectors 704 suitable to communicatively couple pairs of nodes and/or feedback connectors 704 configured to provide communication between three or more nodes). Additionally or alternatively, the feedback connector 704 may communicatively couple two or more nodes having at least one hidden layer between them, i.e., nodes of nonsequential layers of the RNN 700.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

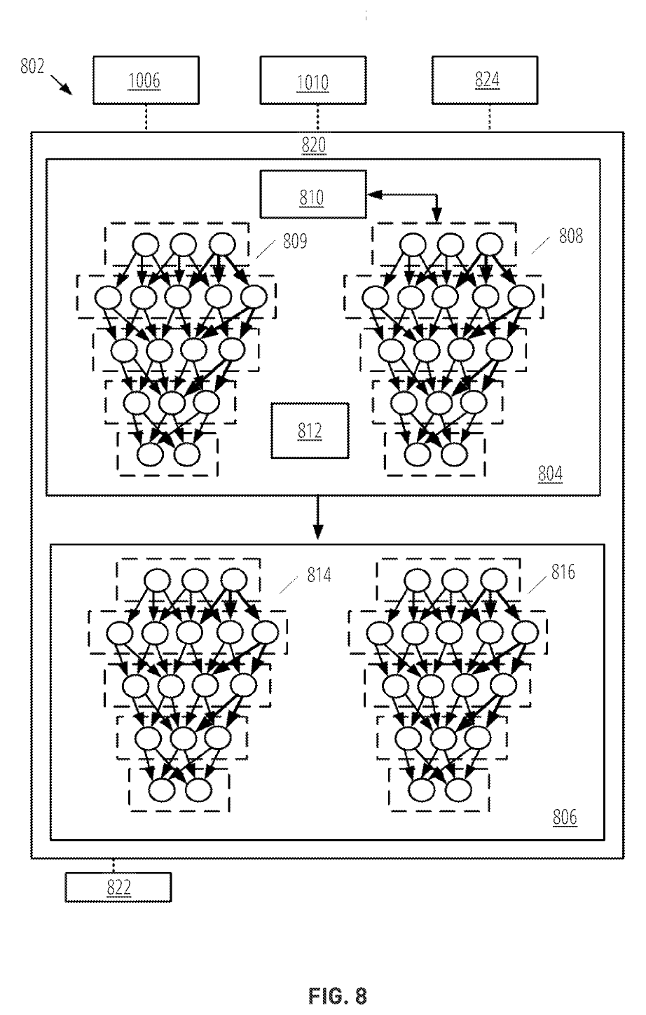

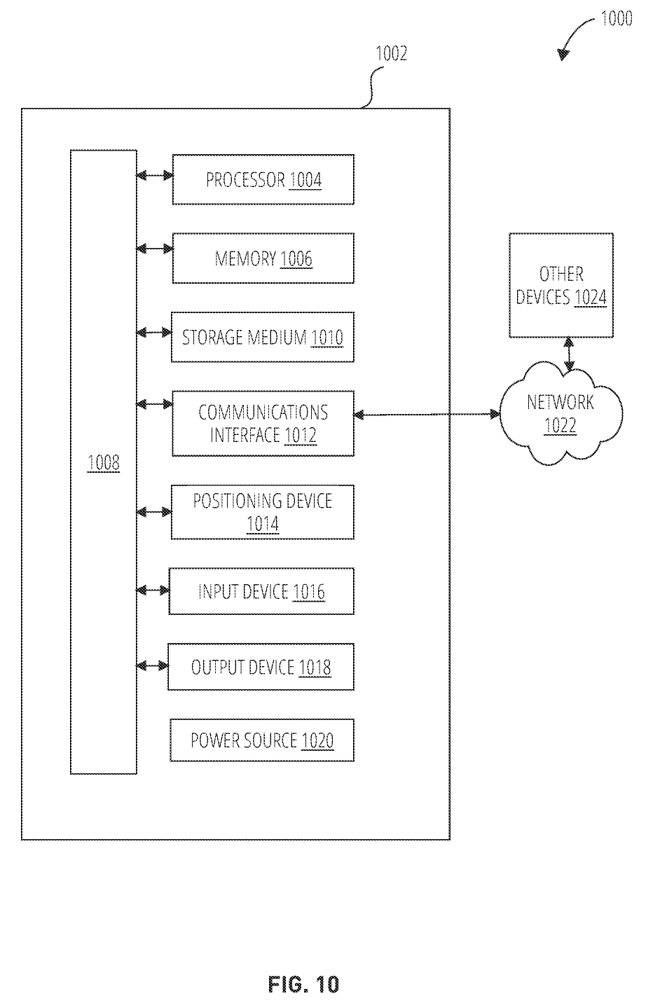

Referring now to FIG. 8 and some embodiments, an artificial intelligence (AI) program 802 may include a front-end network 804 and a back-end network 806. The artificial intelligence program 802 may be implemented on an AI processor 820, such as the processor 1004 of computer 1002 of FIG. 10, a processor of the server 112, a processor of the computing device 108, and/or a dedicated processing device. The instructions associated with the front-end network 804 (also referred to as an “algorithm” or “program”) and the back-end network (also referred to as an “algorithm” or “program”) 806 may be stored in an associated memory device and/or storage device of the system (e.g., storage device 1024 and/or memory 1006 of FIG. 10, etc.) communicatively coupled to the AI processor 820, as shown. Additionally or alternatively, the system may include one or more memory devices and/or storage devices (represented by memory 824 in FIG. 8) for processing use and/or including one or more instructions necessary for operation of the AI program 802. In some embodiments, the AI program 802 may include a deep neural network (e.g., a front-end network 804 configured to perform pre-processing, such as feature recognition, and a back-end network 806 configured to perform an operation on the data set communicated directly or indirectly to the back-end network 806). For instance, the front-end network 804 can include at least one CNN 808 communicatively coupled to send output data to the back-end network 806. In some embodiments, the event model 120 and/or action model 122 may include respective instances of the AI artificial intelligence program 802 and any components thereof.

Additionally or alternatively, the front-end program 804 can include one or more AI algorithms 810, 812 (e.g., statistical models or machine learning programs such as decision tree learning, associate rule learning, recurrent artificial neural networks, support vector machines, and the like). In various embodiments, the front-end program 804 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 808 and/or AI algorithm 810 may be used for image recognition, input categorization, and/or support vector training. In some embodiments and within the front-end program 804, an output from an AI algorithm 810 may be communicated to a CNN 808 or 809, which processes the data before communicating an output from the CNN 808, 809 and/or the front-end program 804 to the back-end program 806. In various embodiments, the back-end network 806 may be configured to implement input and/or model classification, speech recognition, translation, and the like. For instance, the back-end network 806 may include one or more CNNs (e.g., CNN 814) or dense networks (e.g., dense networks 816), as described herein.

For instance and in some embodiments of the AI program 802, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end program 804). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 802 may be trained using a semi-supervised learning process in which some but not all of the output data is known, e.g., a mix of labeled and unlabeled data having the same distribution.

In some embodiments, the AI program 802 may be accelerated via a machine learning framework 822 (e.g., hardware). The machine learning framework may include an index of basic operations, subroutines, and the like (primitives) typically implemented by AI and/or machine learning algorithms. Thus, the AI program 802 may be configured to utilize the primitives of the framework 822 to perform some or all of the calculations required by the AI program 802. Primitives suitable for inclusion in the machine learning framework 822 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

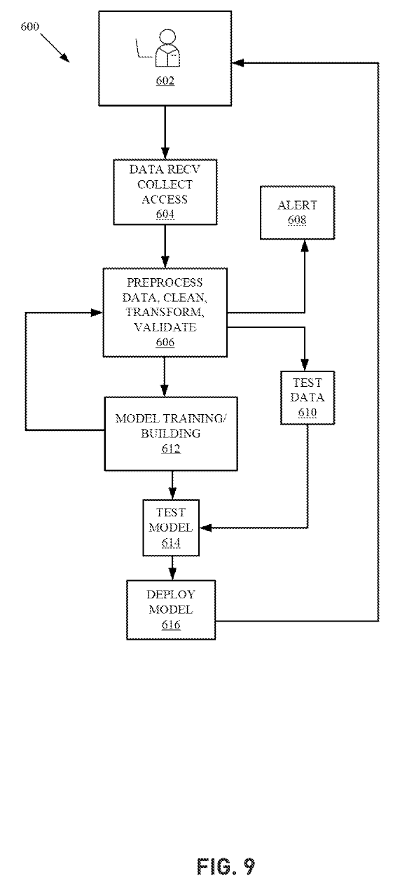

FIG. 9 is a flow chart representing a logic flow 900, according to at least one embodiment, of model development and deployment by machine learning. The logic flow 900 represents at least one example of a machine learning workflow in which operations are implemented in a machine-learning project. For example, the logic flow 900 is one example of a routine to train the event model 120 and/or the action model 122.

In block 902, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, block 902 can represent a starting point. However, with regard to continuing or improving an ongoing machine learning workflow, block 902 can represent an opportunity for further user input or oversight via a feedback loop.

In block 904, data is received, collected, accessed, or otherwise acquired and entered as can be termed data ingestion. In block 906, the data ingested in block 904 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing block 906 is updated with newly ingested data, an updated model will be generated. Block 906 can include data validation, which focuses on confirming that the statistics of the ingested data are as expected, such as that data values are within expected numerical ranges, that data sets are within any expected or required categories, and that data comply with any needed distributions such as within those categories. Block 906 can proceed to block 908 to automatically alert the initiating user, other human or virtual agents, and/or other systems, if any anomalies are detected in the data, thereby pausing or terminating the process flow until corrective action is taken.

In block 910, training test data such as a target variable value is inserted into an iterative training and testing loop. In block 912, model training, a core step of the machine learning workflow, is implemented. A model architecture is trained in the iterative training and testing loop. For example, features in the training test data are used to train the model based on weights and iterative calculations in which the target variable may be incorrectly predicted in an early iteration as determined by comparison in block 914, where the model is tested. Subsequent iterations of the model training, in block 912, may be conducted with updated weights in the calculations.

When compliance and/or success in the model testing in block 914 is achieved, process flow proceeds to block 916, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

FIG. 10 illustrates an example computing system 1000 suitable for implementing various embodiments as described herein. As shown, the computing system 1000 comprises a computer 1002, which is representative of any type of physical and/or virtualized computing device. Examples of the computer 1002 include, but are not limited to, a server, workstation, laptop, mobile device, smartphone, tablet computer, mainframe, distributed computing system, compute cluster, media device, camera, gaming device, a portable digital assistant (PDA), a system-on-chip (SoC), a pager, a television, a wearable device, a virtual machine (VM), or any other device with processing capabilities. In one embodiment, the computer 1002 is representative of some or all of the components of the user devices 102, computing device 108, or the servers 112.

As shown, the computer 1002 includes one or more processors 1004, one or more memories 1006, one or more non-transitory storage media 1010, one or more communications interfaces 1012, one or more positioning devices 1014, one or more input devices 1016, and one or more output devices 1018 communicably coupled via an interconnect 1008. A power source 1020, such as a power supply, battery, or any type of power source may provide power to the computer 1002.

The processor 1004 is representative of any type of processing circuit. For example, the processor 1004 may be a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, a digital signal processor, analog to digital converter, digital to analog converter, and the like.

The memory 1006 is representative of any computer readable medium to store data, code, or other information. The memory 1006 may include volatile memory, such as volatile Random Access Memory (RAM) including a cache area for the temporary storage of data. The memory 1006 may also include non-volatile memory, which can be embedded and/or may be removable. The non-volatile memory can additionally or alternatively include an electrically erasable programmable read-only memory (EEPROM), flash memory or the like. The storage medium 1010 is representative of any type of computer readable medium to store data, code, or other information. Examples of storage media 1010 include solid state drives, hard drives, Redundant Array of Independent Disks (RAID) drives, memory pools, USB storage devices, and the like.

The memory 1006 and storage medium 1010 can store any number and type of computer-executable instructions executed by the processor 1004 to implement the functions of the computer 1002 described herein. For example, the memory 1006 may include such applications as a web browser application and/or a mobile P2P payment system client application. These applications also typically provide a graphical user interface (GUI) on a display that allows the user to communicate with the computer 1002, and, for example a mobile banking system, and/or other devices or systems. In one embodiment, when the user decides to enroll in a mobile banking program, the user downloads or otherwise obtains the mobile banking system client application from a mobile banking system, or from a distinct application server. In other embodiments, the user interacts with a mobile banking system via a web browser application in addition to, or instead of, the mobile P2P payment system client application. Similarly, the memory 1006 and/or storage medium 1010 may be used to store data such as cached data, files for user accounts, user profiles, account balances, transaction histories, files downloaded or received from other devices, and any other data items.

The interconnect 1008 is representative of any type of circuitry to connect the components of the computer 1002. For example, the interconnect 1008 can include or represent, a system bus, a universal serial bus (USB) interface, a peripheral component interconnect (PCI), a Peripheral Component Interconnect-enhanced (PCIe), compute express link (CXL) interconnects, Universal Chiplet Interconnect Express (UCIe) interface, PCI-UCIe interconnects, an interface serial peripheral interconnects (SPIs), integrated interconnects (I2Cs), a high-speed interface connecting the processor 1004 to the memory 1006, individual electrical connections among the components, and electrical conductive traces on a motherboard common to some or all of the above-described components of the computer 1002. As discussed herein, the interconnect 1008 may operatively couple various components with one another, or in other words, electrically connects those components, either directly or indirectly – by way of intermediate component(s) - with one another.

The one or more input devices 1016 are representative of any type of input device for receiving input, such as a keypad, keyboard, touchscreen, touchpad, microphone, camera, fingerprint sensor, mouse, joystick, other pointer device, button, soft key, and the like. The one or more output devices 1018 are representative of any type of device for outputting information, such as a monitor, speaker, haptic feedback module, printer, and the like.

The computer 1002 may use the communications interface 1012 to communicate with one or more other devices 1024 via a network 1022. The communications interface 1012 allows the computer 1002 to communicate with and conduct transactions with other devices and systems, such as the other devices 1024. The communications interface 1012 may be a wired and/or a wireless interface. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communications interface 1012, which can be or include a radio-frequency transceiver, a Bluetooth device, Wi-Fi device, a Near-Field Communication (NFC) device, and other wireless transceivers. In addition, a positioning device 1014 such as a Global Positioning System (GPS) device may be included for navigation and location-related data exchanges, ingoing and/or outgoing. Wi-Fi networks use radio technologies called IEEE 802.11x (a, b, g, n, ac, ax, etc.) to provide secure, reliable, fast wireless connectivity. A Wi-Fi network connects computers to each other, to the Internet, and to wired networks (which use IEEE 802.3-related media and functions). Communications may also and/or alternatively be conducted via wired connections using the communications interface 1012, e.g., using USB, Ethernet, and other physically connected modes of data transfer. The network 1022 may be any one of, or the combination of, wired and/or wireless networks including without limitation a direct connection, a private network (e.g., an intranet), a public network (e.g., the Internet), a Personal Area Network (PAN), a Local Area Network (LAN), a Wide Area Network (WAN), a wireless network, a cellular network, and other communications networks.

The computer 1002 is configured to use the communications interface 1012 as, for example, a network interface to communicate with one or more other devices on a network such as network 1022. In this regard, the computer 1002 utilizes the wireless communications interface 1012 as an antenna operatively coupled to a transmitter and a receiver (together a “transceiver”) included with the communications interface 1012. The communications interface 1012 is configured to provide signals to and receive signals from the transmitter and receiver, respectively. The signals may include signaling information in accordance with the air interface standard of the applicable cellular system of a wireless telephone network. In this regard, the computer 1002 may be configured to operate with one or more air interface standards, communication protocols, modulation types, and access types. By way of illustration, the computer 1002 may be configured to operate in accordance with any of a number of first, second, third, fourth, fifth-generation communication protocols and/or the like. For example, the as a smartphone, the computer 1002 be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The computer 1002 may also be configured to operate in accordance with non-cellular communication mechanisms, such as via a wireless local area network (WLAN) or other communication/data networks.

The communications interface 1012 may also include a payment network interface. The payment network interface may include software, such as encryption software, and hardware, such as a modem, for communicating information to and/or from one or more devices on a network. For example, the computer 1002 may be configured so that it can be used as a credit or debit card by, for example, wirelessly communicating account numbers or other authentication information to a terminal of the network. Such communication could be performed via transmission over a wireless communication protocol such as the NFC protocol.

The computer 1002 may be under the control of any suitable operating system (not pictured). Example operating systems include, but are not limited to, Linux® operating systems, UNIX®, Windows® operating systems, macOS®, iOS®, Android® and any other type of operating system.

The computer 1002 as illustrated diagrammatically represents at least one example of a possible implementation, where alternatives, additions, and modifications are possible for performing some or all of the described methods, operations and functions. Although shown separately, in some embodiments, two or more computers 1002, systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

Aspects of the present disclosure are described herein with reference to flowchart illustrations and/or block diagrams of computer-implemented methods and computing systems according to embodiments of the disclosure. It will be understood that each block of the flowchart illustrations and/or block diagrams, and combinations of blocks in the flowchart illustrations and/or block diagrams, can be implemented by computer readable program instructions that may be provided to a processor of a computer or other programmable data processing apparatus (the term “apparatus” includes systems and computer program products). The processor may execute the computer readable program instructions thereby creating a means for implementing the actions specified in the flowchart illustrations and/or block diagrams. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the actions specified in the flowchart illustrations and/or block diagrams. In particular, the computer readable program instructions may be used to produce a computer-implemented method by executing the instructions to implement the actions specified in the flowchart illustrations and/or block diagrams.

The computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment.

In the flowchart illustrations and/or block diagrams disclosed herein, each block in the flowchart/diagrams may represent a module, segment, or portion of instructions, which comprises one or more executable instructions for implementing the specified logical function(s). In some implementations, the functions noted in the blocks may occur out of the order noted in the Figures. For example, two blocks shown in succession may, in fact, be executed substantially concurrently, or the blocks may sometimes be executed in the reverse order, depending upon the functionality involved.

Computer program instructions are configured to carry out operations of the present disclosure and may be or may incorporate assembler instructions, instruction-set-architecture (ISA) instructions, machine instructions, machine dependent instructions, microcode, firmware instructions, state-setting data, source code, and/or object code written in any combination of one or more programming languages.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The terminology used herein is for the purpose of describing particular embodiments only and is not intended to be limiting of the disclosure. As used herein, the singular forms "a", "an" and "the" are intended to include the plural forms as well, unless the context clearly indicates otherwise. It will be further understood that the terms "comprise" (and any form of comprise, such as "comprises" and "comprising"), "have" (and any form of have, such as "has" and "having"), "include" (and any form of include, such as "includes" and "including"), and "contain" (and any form contain, such as "contains" and "containing") are open-ended linking verbs. As a result, a method or device that "comprises", "has", "includes" or "contains" one or more steps or elements possesses those one or more steps or elements, but is not limited to possessing only those one or more steps or elements. Likewise, a step of a method or an element of a device that "comprises", "has", "includes" or "contains" one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of one or more aspects of the disclosure and the practical application, and to enable others of ordinary skill in the art to understand one or more aspects of the disclosure for various embodiments with various modifications as are suited to the particular use contemplated.

What is claimed is:

1. A method, comprising:
receiving, by an application executing on one or more processors, an indication of a status event;
determining, by a first model executing on the one or more processors based on a system component repository, a first system component associated with the status event;
determining, by the first model based on the first system component and the status event, a modification to the first system component;
generating, by a second model executing on the one or more processors based on the modification, one or more instructions to implement the modification to the first system component; and
initiating, by the application, execution of the one or more instructions to implement the modification to the first system component.

2. The method of claim 1, wherein the first system component is one of a plurality of system components, the plurality of system components comprising: (i) applications, (ii) hardware, and (iii) users, wherein the status event comprising a modification to one or more of: (i) a law, (ii) a regulation, or (iii) a rule.

3. The method of claim 2, wherein the first model comprises a first large language model (LLM) trained based on the system component repository, wherein the system component repository comprises, for each system component, a respective textual description.

4. The method of claim 3, wherein the second model comprises a second LLM trained based on a source code of the applications.

5. The method of claim 4, wherein the second LLM generates the one or more instructions, wherein the one or more instructions comprise modifications to the source code of one of the applications.

6. The method of claim 2, further comprising:
identifying, by the first model based on the system component repository, a second component of the plurality of components associated with the status event; and
displaying, by the application, indications of the first and second components as being associated with the status event in a graphical user interface (GUI).

7. The method of claim 1, further comprising, prior to initiating the execution of the one or more instructions:
outputting, by the application, an indication of the one or more instructions; and
receiving, by the application, an indication of acceptance of the one or more instructions to implement the modification to the first system component.

8. A non-transitory computer-readable storage medium, the computer-readable storage medium including instructions that when executed by a processor, cause the processor to:
receive, by an application, an indication of a status event;
determine, by a first model based on a system component repository, a first system component associated with the status event;
determine, by the first model based on the first system component and the status event, a modification to the first system component;
generate, by a second model based on the modification, one or more instructions to implement the modification to the first system component; and
initiate, by the application, execution of the one or more instructions to implement the modification to the first system component.

9. The computer-readable storage medium of claim 8, wherein the first system component is one of a plurality of system components, the plurality of system components comprising: (i) applications, (ii) hardware, and (iii) users, wherein the status event comprising a modification to one or more of: (i) a law, (ii) a regulation, or (iii) a rule.

10. The computer-readable storage medium of claim 9, wherein the first model comprises a first large language model (LLM) trained based on the system component repository, wherein the system component repository comprises, for each system component, a respective textual description.

11. The computer-readable storage medium of claim 10, wherein the second model comprises a second LLM trained based on a source code of the applications.

12. The computer-readable storage medium of claim 11, wherein the second LLM generates the one or more instructions, wherein the one or more instructions comprise modifications to the source code of one of the applications.

13. The computer-readable storage medium of claim 9, wherein the instructions further cause the processor to:
identify, by the first model based on the system component repository, a second component of the plurality of components associated with the status event; and
display, by the application, indications of the first and second components as being associated with the status event in a graphical user interface (GUI).

14. The computer-readable storage medium of claim 8, wherein the instructions further cause the processor to, prior to initiating the execution of the one or more instructions:
output, by the application, an indication of the one or more instructions; and
receive, by the application, an indication of acceptance of the one or more instructions to implement the modification to the first system component.

15. An apparatus, comprising:
a processor; and
a memory storing instructions that, when executed by the processor, cause the processor to:
receive, by an application, an indication of a status event;
determine, by a first model based on a system component repository, a first system component associated with the status event;
determine, by the first model based on the first system component and the status event, a modification to the first system component;
generate, by a second model based on the modification, one or more instructions to implement the modification to the first system component; and
initiate, by the application, execution of the one or more instructions to implement the modification to the first system component.

16. The apparatus of claim 15, wherein the first system component is one of a plurality of system components, the plurality of system components comprising: (i) applications, (ii) hardware, and (iii) users, wherein the status event comprising a modification to one or more of: (i) a law, (ii) a regulation, or (iii) a rule.

17. The apparatus of claim 16, wherein the first model comprises a first large language model (LLM) trained based on the system component repository, wherein the system component repository comprises, for each system component, a respective textual description.

18. The apparatus of claim 17, wherein the second model comprises a second LLM trained based on a source code of the applications.

19. The apparatus of claim 18, wherein the second LLM generates the one or more instructions, wherein the one or more instructions comprise modifications to the source code of one of the applications.

20. The apparatus of claim 16, wherein the instructions further cause the processor to:
identify, by the first model based on the system component repository, a second component of the plurality of components associated with the status event; and
display, by the application, indications of the first and second components as being associated with the status event in a graphical user interface (GUI).
